(19) United States
(12) Patent Application Publication
(10) Pub. No.: US 2026/0279279 A1
(43) Pub. Date: Sep. 17, 2026

(54) PIXEL, DISPLAY APPARATUS INCLUDING THE SAME AND ELECTRONIC APPARATUS INCLUDING THE SAME

(71) Applicant: SAMSUNG DISPLAY CO., LTD., Yongin-si (KR)

(72) Inventors: KYUNG-BAE KIM, Yongin-si (KR); DONGWOO KIM, Yongin-si (KR); YEONKYUNG KIM, Yongin-si (KR); YONGHEE LEE, Yongin-si (KR)

(21) Appl. No.: 19/359,918

(22) Filed: Oct. 16, 2025

(30) Foreign Application Priority Data
Jan. 16, 2025 (KR) 10-2025-0006556

(51) Int. Cl. G09G 3/3233

(52) U.S. Cl. CPC G09G 3/3233; G09G 2300/043; G09G 2300/0819; G09G 2310/08; G09G 2320/0233

(57) ABSTRACT

A pixel includes a light emitting element receiving a second power voltage, a first switching element including a control electrode connected to a first node, a first electrode connected to a second node, a second electrode connected to the light emitting element and a body electrode connected to the second node, a second switching element including a control electrode receiving a first gate signal, a first electrode connected to a data line and a second electrode connected to the first node, a third switching element including a control electrode receiving an emission signal, a first electrode receiving a first power voltage and a second electrode connected to the second node, a fourth switching element including a control electrode receiving a second gate signal, a first electrode receiving a first voltage and a second electrode connected to the light emitting element.

### CROSS-REFERENCE TO RELATED APPLICATIONS

This U.S. patent application claims priority under 35 U.S.C. § 119 to Korean Patent Application No. 10-2025-0006556, filed on Jan. 16, 2025, in the Korean Intellectual Property Office KIPO, the disclosure of which is incorporated herein in its entirety.

### 1. TECHNICAL FIELD

Embodiments of the present inventive concept relate to a pixel, a display apparatus including the pixel and an electronic apparatus including the pixel. More particularly, embodiments of the present inventive concept relate to a pixel applicable to a high resolution display apparatus, a display apparatus including the pixel and an electronic apparatus including the pixel.

### 2. DISCUSSION OF RELATED ART

A display apparatus may include a display panel and a display panel driver. The display panel includes a plurality of gate lines, a plurality of data lines, a plurality of emission lines and a plurality of pixels. The display panel driver includes a gate driver, a data driver, an emission driver and a driving controller. The gate driver outputs gate signals to the gate lines. The data driver outputs data voltages to the data lines. The emission driver outputs emission signals to the emission lines. The driving controller controls the gate driver, the data driver and the emission driver.

In a conventional pixel structure, a power voltage is applied to a body electrode of a switching transistor of the pixel. During a light emission period, the voltage of the body electrode and a voltage of a source electrode of the switching transistor are substantially the same. During a compensation period, however, the voltage of the body electrode and the voltage of the source electrode differ. This difference can hinder accurate threshold voltage compensation of the switching transistor, resulting in deterioration of luminance uniformity across the display panel and deterioration of overall display quality of the display panel.

### SUMMARY

At least one embodiment of the present inventive concept provides a pixel for enhancing luminance uniformity and display quality of a display panel. A body electrode of a first switching element of the pixel may be connected to a source electrode of the first switching element so that a voltage of the body electrode and a voltage of the source electrode of the first switching element are both matched in a compensation period and in a light emission period. Further, at least one embodiment of the present inventive concept provides a display apparatus including the pixel. Moreover, at least one embodiment of the present inventive concept provides an electronic apparatus including the pixel. Herein the term electronic apparatus and electronic device are used interchangeably.

In an embodiment of a pixel according to the present inventive concept, the pixel includes a light emitting element, a first switching element, a second switching element, a third switching element and a fourth switching element. The first switching element includes a control electrode connected to a first node, a first electrode connected to a second node and a second electrode connected to the light emitting element. The second switching element includes a control electrode configured to receive a first gate signal, a first electrode connected to a data line and a second electrode connected to the first node. The third switching element includes a control electrode configured to receive an emission signal, a first electrode configured to receive a first power voltage and a second electrode connected to the second node. The fourth switching element includes a control electrode configured to receive a second gate signal, a first electrode configured to receive a first voltage and a second electrode connected to the light emitting element. The light emitting element is configured to receive a second power voltage. The first switching element further includes a body electrode connected to the second node.

In an embodiment, the second switching element may further include a body electrode connected to the second node.

In an embodiment, the third switching element may further include a body electrode connected to the second node.

In an embodiment, the second switching element may further include a body electrode connected to the second node and the third switching element may further include a body electrode connected to the second node.

In an embodiment, the first switching element, the second switching element and the third switching element may be P-type transistors. The fourth switching element may be an N-type transistor.

In an embodiment, the first electrode of the fourth switching element may be configured to receive an initialization voltage. In an embodiment, the fourth switching element may further include a body electrode configured to receive the initialization voltage.

In an embodiment, the first electrode of the fourth switching element may be configured to receive the second power voltage.

In an embodiment, the fourth switching element may further include a body electrode configured to receive the second power voltage.

In an embodiment, the first electrode of the fourth switching element may be connected to a ground. In an embodiment, the fourth switching element may further include a body electrode connected to the ground.

In an embodiment, the pixel may further include a first capacitor including a first electrode connected to the first node and a second electrode connected to the second node and a second capacitor including a first electrode connected to the first node and a second electrode configured to receive a second voltage.

In an embodiment, the pixel may further include a third capacitor including a first electrode connected to the first node and a second electrode connected to the light emitting element.

In an embodiment, the first voltage may be substantially the same as the second voltage.

In an embodiment, the emission signal may have an active level in a first period. The first gate signal may have an active level in the first period. The second gate signal may have an active level in the first period. The first power voltage may have a first level in the first period.

In an embodiment, the first switching element, the second switching element, the third switching element and the fourth switching element may be turned on in the first period.

In an embodiment, the emission signal may have an inactive level in a second period subsequent to the first period. The first gate signal may have the active level in the second period. The second gate signal may have the active level in the second period. The first power voltage may have a second level lower than the first level in the second period.

In an embodiment, a voltage difference between the body electrode of the first switching element and the first electrode of the first switching element may be less than a threshold voltage of the third switching element in the second period.

In an embodiment, the first switching element, the second switching element and the fourth switching element may be turned on in the second period. The third switching element may be turned off in the second period.

In an embodiment, the emission signal may have the active level in a third period subsequent to the second period. The first gate signal may have an inactive level in the third period. The second gate signal may have the active level in the third period. The first power voltage may have the first level in the third period.

In an embodiment, the first switching element, the third switching element and the fourth switching element may be turned on in the third period. The second switching element may be turned off in the third period.

In an embodiment, the emission signal may have the active level in a fourth period subsequent to the third period. The first gate signal may have the inactive level in the fourth period. The second gate signal may have an inactive level in the fourth period. The first power voltage may have the first level in the fourth period.

In an embodiment, the first switching element and the third switching element may be turned on in the fourth period. The second switching element and the fourth switching element may be turned off in the fourth period.

In an embodiment of a display apparatus according to the present inventive concept, the display apparatus includes a display panel, a gate driver and a data driver. The display panel includes a pixel. The gate driver is configured to output a gate signal to the pixel. The data driver is configured to output a data voltage to the pixel. The pixel includes a light emitting element, a first switching element, a second switching element, a third switching element and a fourth switching element. The first switching element includes a control electrode connected to a first node, a first electrode connected to a second node and a second electrode connected to the light emitting element. The second switching element includes a control electrode configured to receive a first gate signal, a first electrode connected to a data line and a second electrode connected to the first node. The third switching element includes a control electrode configured to receive an emission signal, a first electrode configured to receive a first power voltage and a second electrode connected to the second node. The fourth switching element includes a control electrode configured to receive a second gate signal, a first electrode configured to receive a first voltage and a second electrode connected to the light emitting element. The light emitting element is configured to receive a second power voltage. The first switching element further includes a body electrode connected to the second node.

In an embodiment of an electronic apparatus (e.g., an electronic device) according to the present inventive concept, the electronic apparatus includes a display panel, a gate driver, a data driver, a driving controller and a processor. The display panel includes a pixel. The gate driver is configured to output a gate signal to the pixel. The data driver is configured to output a data voltage to the pixel. The driving controller is configured to control an operation of the gate driver and an operation of the data driver. The processor is configured to output input image data and an input control signal to the driving controller. The pixel includes a light emitting element, a first switching element, a second switching element, a third switching element and a fourth switching element. The first switching element includes a control electrode connected to a first node, a first electrode connected to a second node and a second electrode connected to the light emitting element. The second switching element includes a control electrode configured to receive a first gate signal, a first electrode connected to a data line and a second electrode connected to the first node. The third switching element includes a control electrode configured to receive an emission signal, a first electrode configured to receive a first power voltage and a second electrode connected to the second node. The fourth switching element includes a control electrode configured to receive a second gate signal, a first electrode configured to receive a first voltage and a second electrode connected to the light emitting element. The light emitting element is configured to receive a second power voltage. The first switching element further includes a body electrode connected to the second node.

According to one or more embodiments, a pixel, a display apparatus including the pixel and an electronic apparatus (e.g., an electronic device) including the pixel are provided. In these embodiments, a body electrode of a first switching element of the pixel and a source electrode of the first switching element are connected to each other. As a result, a voltage of the body electrode of the first switching element and a voltage of the source electrode of the first switching element may be both matched in a compensation period and in a light emission period.

When the voltage of the body electrode of the first switching element and the voltage of the source electrode of the first switching element are matched both in the compensation period and in the light emission period, a threshold voltage of the first switching element may be adequately compensated.

Thus, luminance uniformity of a display panel of the display apparatus and display quality of the display panel may be enhanced.

The pixel may include four switching elements and three capacitors. This relatively small number of switching elements and capacitors may allow the pixel to be applied to a high resolution display apparatus.

In addition, when the body electrode of the second switching element and the body electrode of the third switching element are connected to the source electrode of the first switching element, the body electrode of the first switching element, the body electrode of the second switching element and the body electrode of the third switching element may be connected to a same node so that wells between the first to third switching elements need not be separated. As a result, the pixel may be more suitable for use in the high resolution display apparatus.

### BRIEF DESCRIPTION OF THE DRAWINGS

The above and other features of the present inventive concept will become more apparent by describing in detailed embodiments thereof with reference to the accompanying drawings, in which:

FIG. 1 is a block diagram illustrating a display apparatus according to an embodiment of the present inventive concept;

FIG. 2 is a circuit diagram illustrating a pixel of a display panel of the display apparatus of FIG. 1 according to an embodiment of the present inventive concept;

FIG. 3 is a timing diagram illustrating an example of input signals applied to the pixel of FIG. 2;

FIG. 4 is a circuit diagram illustrating an operation of the pixel of FIG. 2 in a first period according to an embodiment of the present inventive concept;

FIG. 5 is a circuit diagram illustrating an operation of the pixel of FIG. 2 in a second period according to an embodiment of the present inventive concept;

FIG. 6 is a circuit diagram illustrating an operation of the pixel of FIG. 2 in a third period according to an embodiment of the present inventive concept;

FIG. 7 is a circuit diagram illustrating an operation of the pixel of FIG. 2 in a fourth period according to an embodiment of the present inventive concept;

FIG. 8 is a circuit diagram illustrating a pixel of a display panel of a display apparatus according to an embodiment of the present inventive concept;

FIG. 9 is a circuit diagram illustrating a pixel of a display panel of a display apparatus according to an embodiment of the present inventive concept;

FIG. 10 is a circuit diagram illustrating a pixel of a display panel of a display apparatus according to an embodiment of the present inventive concept;

FIG. 11 is a block diagram illustrating an electronic apparatus according to an embodiment of the present inventive concept;

FIG. 12 is a diagram illustrating an example in which the electronic apparatus of FIG. 11 is implemented as a virtual reality (VR) display system;

FIG. 13 is a diagram illustrating an example in which the electronic apparatus of FIG. 11 is implemented as a smartphone;

FIG. 14 is a block diagram illustrating electronic apparatuses according to an embodiment of the present inventive concept; and

FIG. 15 are schematic diagrams illustrating the electronic apparatuses of FIG. 14.

### DETAILED DESCRIPTION

Hereinafter, the present inventive concept will be explained in detail with reference to the accompanying drawings.

One or more embodiments of the inventive concept relate to a pixel of a display device. A body electrode of a switching element in the pixel may be connected to a source electrode of the switching element so that a voltage of the body electrode can match a voltage of the source electrode in both a light emission period and a compensation period. In some embodiments, the body electrodes of other switching elements in the pixel are also connected to the same node to reduce well separation and allow for a more compact layout. These configurations may reduce body–source voltage mismatch, enhance threshold voltage compensation, and enhance luminance uniformity and display quality, without requiring a large number of components.

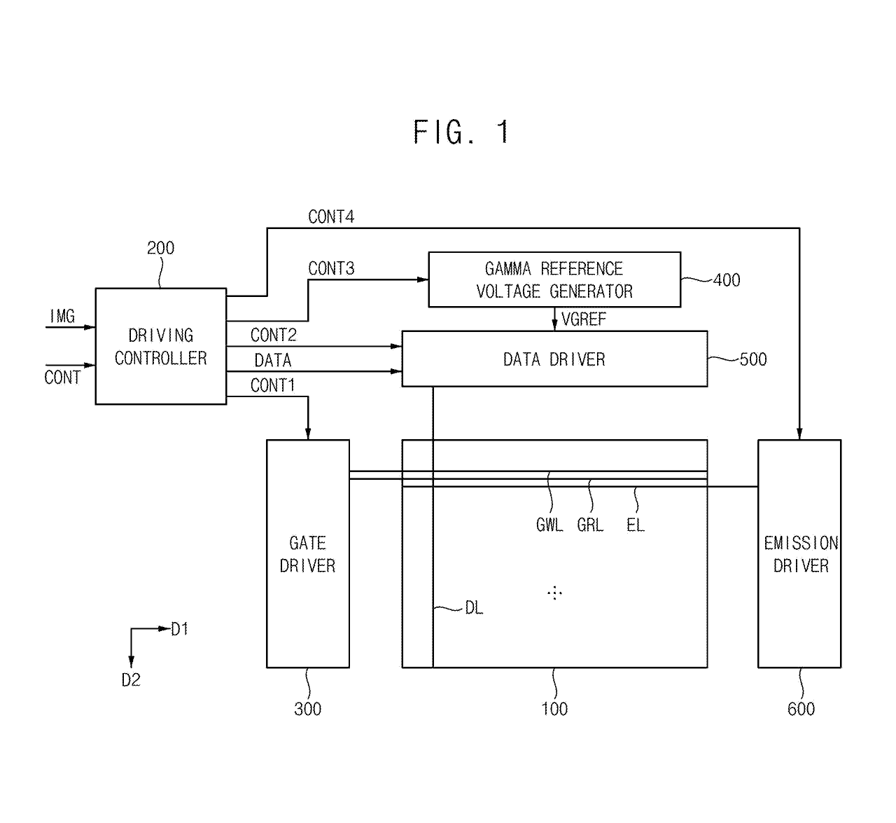

FIG. 1 is a block diagram illustrating a display apparatus according to an embodiment of the present inventive concept.

Referring to FIG. 1, the display apparatus includes a display panel 100 and a display panel driver. The display panel driver includes a driving controller 200 (e.g., a control circuit), a gate driver 300 (e.g., a first driver circuit), a gamma reference voltage generator 400, a data driver 500 (e.g., a second driver circuit) and an emission driver 600 (e.g., a third driver circuit).

The display panel 100 includes a display region in which an image is displayed and a peripheral region surrounding or adjacent to the display region.

The display panel 100 includes a plurality of gate lines GWL and GRL, a plurality of data lines DL, a plurality of emission lines EL and a plurality of pixels electrically connected to the gate lines GWL and GRL, the data lines DL and the emission lines EL. The gate lines GWL and GRL may extend in a first direction D1, the data lines DL may extend in a second direction D2 crossing the first direction D1 and the emission lines EL may extend in the first direction D1. The gate lines GWL and GRL may carry gate signals that control when switching elements in the pixels turn on or off. The data lines DL may carry data voltages that set brightnesses or color values of the pixels. The emission lines EL may carry control signals that determine when the light emitting element of the pixels are driven.

The driving controller 200 receives input image data IMG and an input control signal CONT. The input image data IMG and the input control signal CONT may be received from an external apparatus (e.g. a processor, an application processor, a host or a set apparatus). For example, the input image data IMG may include color image data such as red image data, green image data and blue image data. The color image data may further include or alternatively include white image data. For example, instead of the color image data including red image data, green image data and blue image data, the color image data may include magenta image data, cyan image data and yellow image data. The input control signal CONT may include a master clock signal and a data enable signal. The input control signal CONT may further include a vertical synchronizing signal and a horizontal synchronizing signal. The master clock signal may provide timing reference for synchronizing operations across the display device. The data enable signal may indicate a valid period for writing image data to the pixels. The vertical synchronizing signal may mark the start of a new frame and the horizontal synchronizing signal may mark the start of a row within the frame.

The driving controller 200 may generate a first control signal CONT1, a second control signal CONT2, a third control signal CONT3, a fourth control signal CONT4 and a data signal DATA based on the input image data IMG and the input control signal CONT.

The driving controller 200 may generate the first control signal CONT1 for controlling an operation of the gate driver 300 based on the input control signal CONT, and output the first control signal CONT1 to the gate driver 300. The first control signal CONT1 may include a vertical start signal and a gate clock signal.

The driving controller 200 may generate the second control signal CONT2 for controlling an operation of the data driver 500 based on the input control signal CONT, and output the second control signal CONT2 to the data driver 500. The second control signal CONT2 may include a horizontal start signal and a load signal.

The driving controller 200 may generate the data signal DATA based on the input image data IMG. The driving controller 200 may output the data signal DATA to the data driver 500.

The driving controller 200 may generate the third control signal CONT3 for controlling an operation of the gamma reference voltage generator 400 based on the input control signal CONT, and output the third control signal CONT3 to the gamma reference voltage generator 400. The gamma reference voltage generator 400 may generate reference or gamma voltages used by the data driver 500 to convert input digital image data into corresponding analog data voltages for the pixels.

The driving controller 200 may generate the fourth control signal CONT4 for controlling an operation of the emission driver 600 based on the input control signal CONT, and output the fourth control signal CONT4 to the emission driver 600.

The gate driver 300 may generate gate signals for driving the gate lines GWL and GRL in response to the first control signal CONT1 received from the driving controller 200. The gate driver 300 may output the gate signals to the gate lines GWL and GRL.

The gamma reference voltage generator 400 may generate a gamma reference voltage VGREF in response to the third control signal CONT3 received from the driving controller 200. The gamma reference voltage generator 400 may provide the gamma reference voltage VGREF to the data driver 500. The gamma reference voltage VGREF may have a value corresponding to a level of the data signal DATA. For example, a higher level of the data signal DATA may correspond to a higher gamma reference voltage, resulting in a brighter output from a light emitting element of a pixel.

In an embodiment, the gamma reference voltage generator 400 is disposed within the driving controller 200, or within the data driver 500.

The data driver 500 may receive the second control signal CONT2 and the data signal DATA from the driving controller 200, and receive the gamma reference voltages VGREF from the gamma reference voltage generator 400. The data driver 500 may convert the data signal DATA into analog data voltages using the gamma reference voltages VGREF. The data driver 500 may output the analog data voltages to the data lines DL.

The emission driver 600 may generate emission signals to drive the emission lines EL in response to the fourth control signal CONT4 received from the driving controller 200. The emission driver 600 may output the emission signals to the emission lines EL.

Although FIG. 1 illustrates the gate driver 300 being disposed on a first side of the display panel 100 and the emission driver 600 being disposed on a second side of the display panel 100 opposite to the first side in FIG. 1, the present inventive concept is not limited thereto. For example, both of the gate driver 300 and the emission driver 600 may be disposed on the same side (e.g., both on the first side of the display panel 100 or both on the second side of the display panel 100). The gate driver 300 and the emission driver 600 may be integrally formed when formed on the same side. Alternately, both of the gate driver 300 and the emission driver 600 may be disposed on both sides (e.g., the first side and the second side) of the display panel 100. For example, a first part of the gate driver 300 and a first part of the emission driver 600 may be disposed on the first side while a second part of the gate driver 300 and a second part of the emission driver 600 may be disposed on the second side.

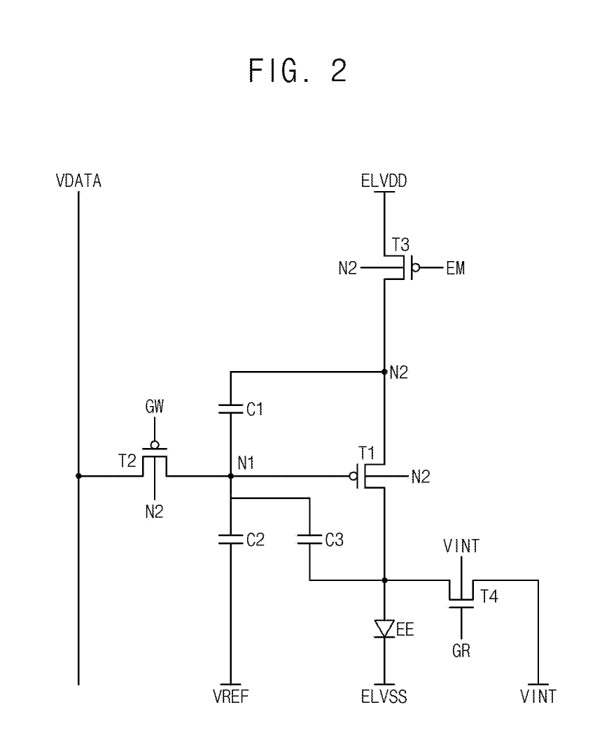

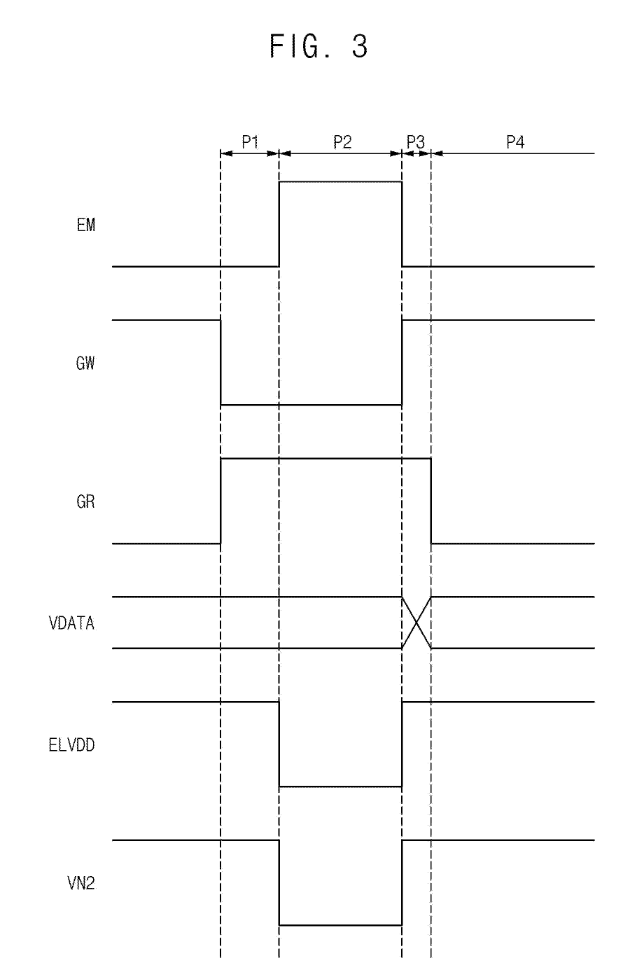

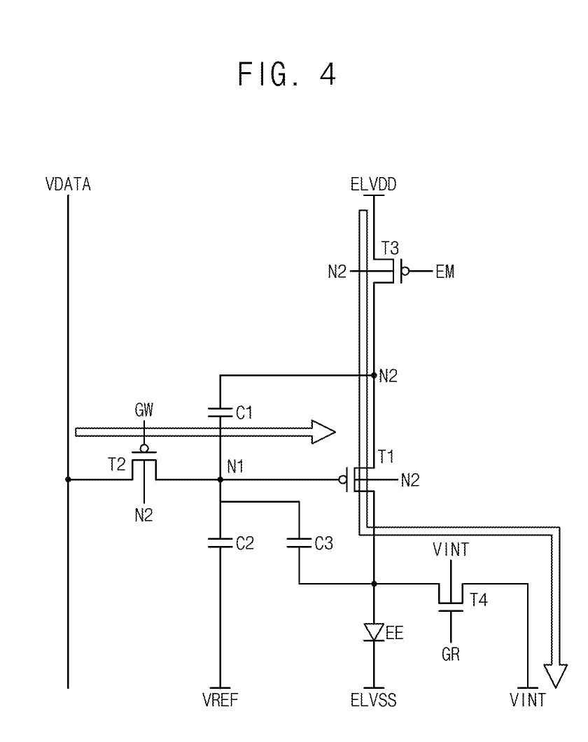

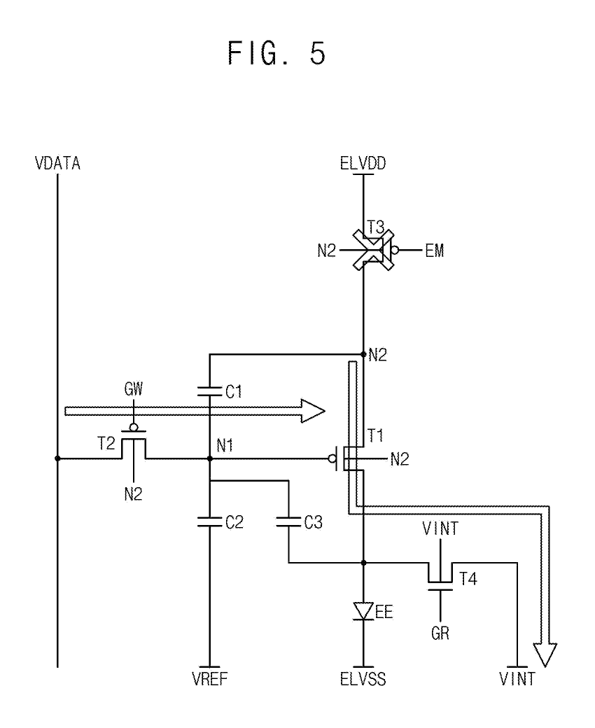

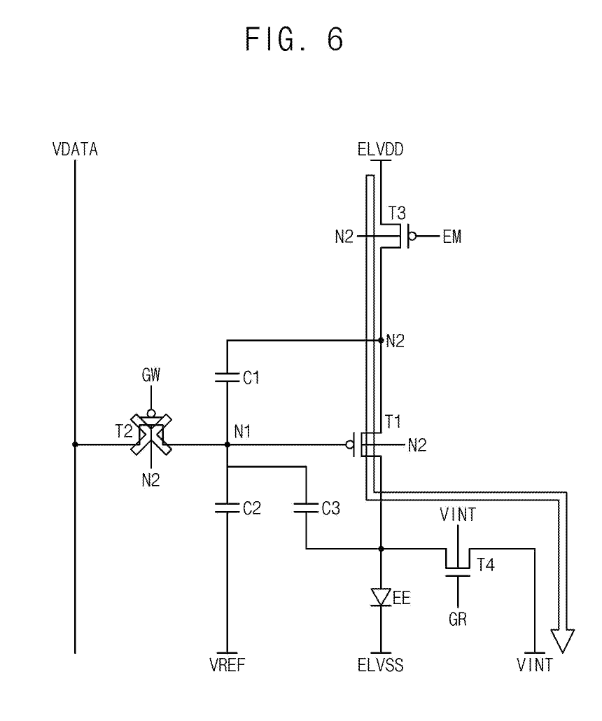

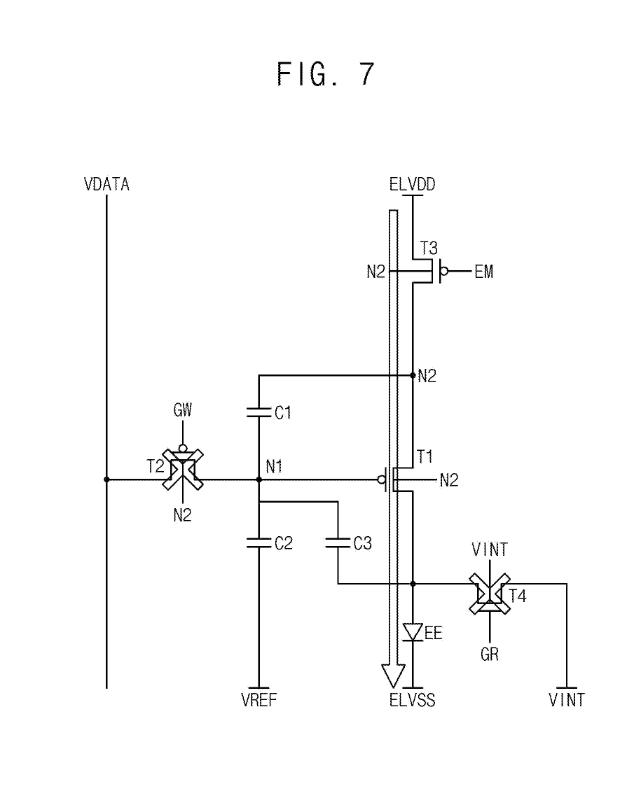

FIG. 2 is a circuit diagram illustrating the pixel of the display panel 100 of FIG. 1. FIG. 3 is a timing diagram illustrating an example of input signals applied to the pixel of FIG. 2. FIG. 4 is a circuit diagram illustrating an operation of the pixel of FIG. 2 in a first period P1. FIG. 5 is a circuit diagram illustrating an operation of the pixel of FIG. 2 in a second period P2. FIG. 6 is a circuit diagram illustrating an operation of the pixel of FIG. 2 in a third period P3. FIG. 7 is a circuit diagram illustrating an operation of the pixel of FIG. 2 in a fourth period P4.

Referring to FIGS. 1 to 7, the display panel 100 includes a plurality of pixels. Each of the pixels includes a light emitting element EE. For example, the light emitting element EE may be a micro organic light emitting diode (Micro-OLED).

For example, the display apparatus according to the present embodiment may be a micro display apparatus including the micro organic light emitting diode (Micro-OLED). For example, the pixel may be formed on a silicon substrate. For example, the display apparatus may be a micro display apparatus including the pixels formed on the silicon substrate.

The pixel receives a first gate signal GW, a second gate signal GR, the data voltage VDATA and the emission signal EM and the light emitting element EE of the pixel emits light corresponding to the level of the data voltage VDATA to display the image.

The pixel includes the light emitting element EE, a first switching element T1, a second switching element T2, a third switching element T3 and a fourth switching element T4. In an embodiment, each of the switching elements may be transistors. For example, the first through third switching elements T1-T3 may be transistors of a first type and the fourth switching element T4 may be a transistor of a second type that is complementary to the first type.

The first switching element T1 includes a control electrode connected to a first node N1, a first electrode connected to a second node N2 and a second electrode connected to an anode electrode of the light emitting element EE. The first switching element T1 may further include a body electrode connected to the second node N2. The body electrode of the first switching element T1 may be connected to a source electrode of the first switching element T1. The first switching element may be referred to as a driving element since it may provide current to the light emitting element EE.

The second switching element T2 includes a control electrode receiving the first gate signal GW, a first electrode connected to a data line receiving the data voltage VDATA and a second electrode connected to the first node N1.

The second switching element T2 may write the data voltage VDATA to the control electrode of the first switching element T1 in response to the first gate signal GW.

The third switching element T3 includes a control electrode receiving the emission signal EM, a first electrode receiving a first power voltage ELVDD and a second electrode connected to the second node N2. The first power voltage ELVDD, when applied to a pixel, is a voltage that may cause current flow and hence delivery of power to the pixel. For example, the first power voltage ELVDD may power the light emitting element EE of the pixel.

The fourth switching element T4 includes a control electrode receiving the second gate signal GR, a first electrode receiving a first voltage and a second electrode connected to the anode electrode of the light emitting element EE. In the present embodiment, the first voltage may be an initialization voltage VINT. The fourth switching element T4 includes the control electrode receiving the second gate signal GR, the first electrode receiving the initialization voltage VINT and the second electrode connected to the anode electrode of the light emitting element EE.

A second power voltage ELVSS is applied to a cathode electrode of the light emitting element EE.

For example, the first power voltage ELVDD may be a high power voltage for emitting the light emitting element EE and the second power voltage ELVSS may be a low power voltage for emitting the light emitting element EE. The first power voltage ELVDD may be greater than the second power voltage ELVSS. In an embodiment, the second power voltage ELVSS may be a ground voltage but is not limited thereto. For example, the first power voltage ELVDD may be a positive voltage while the second power voltage ELVSS may be a negative voltage.

The pixel may further include a first capacitor C1 including a first electrode connected to the first node N1 and a second electrode connected to the second node N2 and a second capacitor C2 including a first electrode connected to the first node N1 and a second electrode receiving a second voltage. In the present embodiment, the second voltage may be a reference voltage VREF. In the present embodiment, the second voltage VREF may be different from the first voltage VINT.

The pixel may further include a third capacitor C3 including a first electrode connected to the first node N1 and a second electrode connected to the anode electrode of the light emitting element EE.

For example, the first switching element T1, the second switching element T2 and the third switching element T3 may be P-type transistors. The fourth switching element T4 may be an N-type transistor.

For example, the first switching element T1, the second switching element T2 and the third switching element T3 may be low temperature polysilicon (LTPS) thin film transistors. For example, the fourth switching element T4 may be an oxide semiconductor transistor.

For example, the second switching element T2 may further include a body electrode receiving the first power voltage ELVDD. For example, the third switching element T3 may further include a body electrode receiving the first power voltage ELVDD.

For example, the body electrode of the second switching element T2 may be connected to the source electrode of the first switching element T1. In addition, the body electrode of the third switching element T3 may be connected to the source electrode of the first switching element T1. For example, FIG. 2 illustrates that the body electrodes of the first and second switching elements T1 and T2 may be connected to the second node N2 to indicate an electrical connection to the source node of the first switching element. Accordingly, the second node N2 may be referred to as the source node N2.

For example, the fourth switching element T4 may further include a body electrode receiving the initialization voltage VINT.

As shown in FIGS. 3 and 4, in the first period P1, the emission signal EM may have an active level, the first gate signal GW may have an active level and the second gate signal GR may have an active level. In addition, the first power voltage ELVDD may have a first level in the first period P1. The first period P1 may be an initialization and data writing period.

Herein, the switching elements receiving the signals are P-type transistors, an active level of the signal may be a low level and an inactive level of the signal may be a high level. In contrast, the switching elements receiving the signals are N-type transistors, an active level of the signal may be a high level and an inactive level of the signal may be a low level.

In the first period P1, the first switching element T1, the second switching element T2, the third switching element T3 and the fourth switching element T4 may be turned on.

In the first period P1, the second switching element T2 provides the data voltage VDATA to the first node N1 so that the data voltage VDATA may be written to the first capacitor C1. In addition, a conduction path is formed through the third switching element T3, the first switching element T1 and the fourth switching element T4, allowing the first electrode of the first switching element T1 and the anode electrode of the light emitting element EE to be initialized.

As shown in FIGS. 3 and 5, in the second period P2 subsequent to the first period P1, the emission signal EM may have an inactive level, the first gate signal GW may have the active level and the second gate signal GR may have the active level. In addition, the first power voltage ELVDD may have a second level lower than the first level in the second period P2. The second period P2 may be a compensation period.

In the second period P2, a voltage difference between the body electrode of the first switching element T1 and the first electrode of the first switching element T1 may be less than a threshold voltage of the third switching element T3.

Thus, in the second period P2, the first switching element T1, the second switching element T2 and the fourth switching element T4 may be turned on and the third switching element T3 may be turned off.

In the second period P2, the second switching element T2 transmits the data voltage VDATA to the first node N1 so that a voltage of the first node N1 may be the data voltage VDATA and a voltage VN2 of the second node N2 may be VDATA-VTH. Herein, VDATA may be the data voltage and VTH may be a threshold voltage of the first switching element T1. In the second period P2, the threshold voltage of the first switching element T1 may be compensated.

As shown in FIGS. 3 and 6, in the third period P3 subsequent to the second period P2, the emission signal EM may have the active level, the first gate signal GW may have an inactive level and the second gate signal GR may have the active level. In addition, in the third period P3, the first power voltage ELVDD may have the first level. The third period P3 may be an anode holding period.

In the third period P3, the first switching element T1, the third switching element T3 and the fourth switching element T4 may be turned on and the second switching element T2 may be turned off.

In the third period P3, a writing of the data voltage VDATA may be terminated and the anode electrode of the light emitting element EE may be initialized by the initialization voltage VINT.

As shown in FIGS. 3 and 7, in the fourth period P4 subsequent to the third period P3, the emission signal EM may have the active level, the first gate signal GW may have the inactive level and the second gate signal GR may have the inactive level. In addition, in the fourth period P4, the first power voltage ELVDD may have the first level. The fourth period P4 may be a light emission period.

In the fourth period P4, the first switching element T1 and the third switching element T3 may be turned on and the second switching element T2 and the fourth switching element T4 may be turned off.

In the fourth period P4, the first power voltage ELVDD is applied to the first switching element T1, generating a driving current that may be applied to the light emitting element EE. The light emitting element EE may emit a light at a luminance corresponding to the driving current. The driving current may be determined depending on a gate-source voltage of the first switching element T1.

In a conventional pixel structure where the first power voltage ELVDD is applied to the body electrode of the first switching element T1, the voltage of the body electrode of the first switching element T1 and the voltage VN2 of the source electrode N2 of the first switching element T1 may both be the first power voltage ELVDD and thus be substantially the same in a light emission period P4. However, in the conventional pixel structure, the voltage of the body electrode of the first switching element T1 may be the first power voltage ELVDD, while the voltage VN2 of the source electrode N2 of the first switching element T1 may be a sum of the initialization voltage VINT and a threshold voltage VTH of the first switching element T1 (e.g., VINT+VTH) during a compensation period P2.

In the conventional pixel structure, both the body voltage and the source voltage of the first switching element T1 are ELVDD in the light emission period P4, whereas in the compensation period the body voltage is ELVDD and the source voltage is VINT+VTH.

In the conventional pixel structure, the voltage of the body electrode and the voltage of the source electrode of the first switching element T1 differ during the compensation period P2, which may result in poor threshold voltage compensation for the first switching element T1.

When the threshold voltage of the first switching element T1 is not adequately compensated, the luminance uniformity of the display panel 100 may deteriorate, and accordingly, the overall display quality of the display panel 100 may also deteriorate.

In the pixel structure of the present embodiment, the body electrode of the first switching element T1 may be connected to the source electrode N2 of the first switching element T1.

In the pixel structure of the present embodiment, the body electrode of the first switching element T1 is connected to the source electrode N2 of the first switching element T1. In the light emitting period P4, the voltage of the body electrode of the first switching element T1 and the voltage VN2 of the source electrode N2 of the first switching element T1 may be both the first power voltage ELVDD and be substantially the same as each other. In the compensation period P2, the voltage of the body electrode of the first switching element T1 and the voltage VN2 of the source electrode N2 of the first switching element T1 may both be the sum VINT+VTH, where VINT is the initialization voltage VINT and VTH is the threshold voltage of the first switching element T1, and again be substantially the same as each other.

In the pixel structure of the present embodiment, the body voltage and the source voltage of the first switching element T1 are both ELVDD during the light emission period P4. During the compensation period P2, the body voltage and the source voltage of the first switching element T1 are both VINT+VTH, where VINT is the initialization voltage and VTH is the threshold voltage of the first switching element T1.

In the pixel structure of the present embodiment, the voltage of the body electrode and the voltage of the source electrode of the first switching element T1 are substantially the same in both the compensation period P2 and the light emission period P4. As a result, the threshold voltage of the first switching element T1 may be adequately compensated.

When the threshold voltage of the first switching element T1 is adequately compensated, a luminance uniformity of the display panel 100 may be enhanced and accordingly, a display quality of the display panel 100 may be enhanced.

In addition, in the pixel structure of the present embodiment, the body electrode of the second switching element T2 and the body electrode of the third switching element T3 may be connected to the source electrode N2 of the first switching element T1.

When the body electrode of the first switching element T1, the body electrode of the second switching element T2 and the body electrode of the third switching element T3 are connected to the same node (e.g., N2), wells between the first to third switching elements T1 to T3 need not be separated. As a result, the pixel structure may be applied to achieve a display panel with a high resolution.

According to the present embodiment, the body electrode of the first switching element T1 is connected to the source electrode N2 of the first switching element T1, such that the voltage of the body electrode of the first switching element T1 and the voltage of the source electrode N2 may be matched (or substantially the same) in both the compensation period P2 and in the light emission period P4.

When the voltage of the body electrode of the first switching element T1 and the voltage of the source electrode of the first switching element T1 are matched in the compensation period P2 and in the light emission period P4, the threshold voltage of the first switching element T1 may be adequately compensated.

Thus, the luminance uniformity of the display panel 100 and the display quality of the display panel 100 may be enhanced.

The pixel may include four switching elements T1, T2, T3 and T4 and three capacitors C1, C2 and C3. This relatively small number of switching elements and capacitors allows the pixel to be suitable for use in a high resolution display apparatus.

In addition, when the body electrode of the second switching element T2 and the body electrode of the third switching element T3 are connected to the source electrode N2 of the first switching element T1, the body electrodes of the first to third switching elements T1 to T3 are connected to the same node. As a result, wells between the first to third switching elements T1 to T3 need not be separated, making the pixel more suitable for application in a high resolution display apparatus.

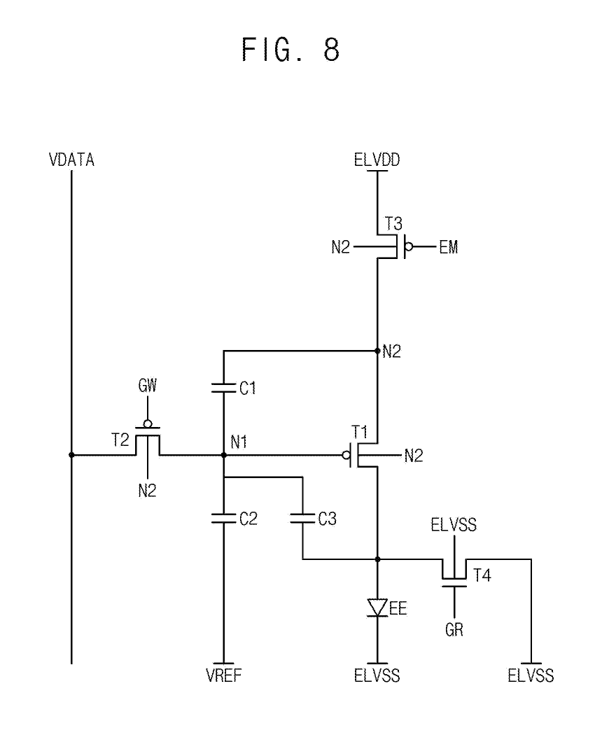

FIG. 8 is a circuit diagram illustrating a pixel of a display panel 100 of a display apparatus according to an embodiment of the present inventive concept.

The display apparatus according to the present embodiment is substantially the same as the display apparatus of the previous embodiment explained referring to FIGS. 1 to 7 except for the fourth switching element of the pixel. Thus, the same reference numerals will be used to refer to the same or like parts as those described in the previous embodiment of FIGS. 1 to 7 and any repetitive explanation concerning the above elements will be omitted.

Referring to FIGS. 1 and 3 to 8, the display panel 100 includes a plurality of pixels. Each of the pixels includes a light emitting element EE. For example, the light emitting element EE may be a micro organic light emitting diode (Micro-OLED).

The pixel receives a first gate signal GW, a second gate signal GR, the data voltage VDATA and the emission signal EM and the light emitting element EE of the pixel emits light corresponding to the level of the data voltage VDATA to display the image.

The pixel includes the light emitting element EE, a first switching element T1, a second switching element T2, a third switching element T3 and a fourth switching element T4.

The first switching element T1 includes a control electrode connected to a first node N1, a first electrode connected to a second node N2 and a second electrode connected to an anode electrode of the light emitting element EE. The first switching element T1 may further include a body electrode connected to the second node N2. The body electrode of the first switching element T1 may be connected to a source electrode of the first switching element T1.

The fourth switching element T4 includes a control electrode receiving the second gate signal GR, a first electrode receiving a first voltage and a second electrode connected to the anode electrode of the light emitting element EE. In the present embodiment, the first voltage may be a second power voltage ELVSS. The fourth switching element T4 includes the control electrode receiving the second gate signal GR, the first electrode receiving the second power voltage ELVSS and the second electrode connected to the anode electrode of the light emitting element EE.

For example, the fourth switching element T4 may further include a body electrode receiving the second power voltage ELVSS.

A second power voltage ELVSS is applied to a cathode electrode of the light emitting element EE.

The pixel may further include a first capacitor C1 including a first electrode connected to the first node N1 and a second electrode connected to the second node N2 and a second capacitor C2 including a first electrode connected to the first node N1 and a second electrode receiving a second voltage (e.g. a reference voltage VREF). In the present embodiment, the second voltage VREF may be different from the first voltage VINT.

The pixel may further include a third capacitor C3 including a first electrode connected to the first node N1 and a second electrode connected to the anode electrode of the light emitting element EE.

In the present embodiment, the first switching element T1, the second switching element T2 and the third switching element T3 may be P-type transistors. The fourth switching element T4 may be an N-type transistor.

For example, the second switching element T2 may further include a body electrode receiving the first power voltage ELVDD. For example, the third switching element T3 may further include a body electrode receiving the first power voltage ELVDD.

For example, the body electrode of the second switching element T2 may be connected to the source electrode of the first switching element T1. In addition, the body electrode of the third switching element T3 may be connected to the source electrode of the first switching element T1.

According to the present embodiment, the body electrode of the first switching element T1 is connected to the source electrode N2 of the first switching element T1, such that the voltage of the body electrode of the first switching element T1 and the voltage of the source electrode of the first switching element T1 may be matched in both the compensation period P2 and in the light emission period P4.

When the voltage of the body electrode of the first switching element T1 and the voltage of the source electrode of the first switching element T1 are matched in the compensation period P2 and in the light emission period P4, the threshold voltage of the first switching element T1 may be adequately compensated.

Thus, luminance uniformity of the display panel 100 and the display quality of the display panel 100 may be enhanced.

The pixel may include four switching elements T1, T2, T3 and T4 and three capacitors C1, C2 and C3. This relatively small number of switching elements and capacitors may allow the pixel to be applied to a high resolution display apparatus.

In addition, when the body electrode of the second switching element T2 and the body electrode of the third switching element T3 are connected to the source electrode N2 of the first switching element T1, the body electrodes of the first to third switching elements T1 to T3 are connected to the same node. As a result, wells between the first to third switching elements T1 to T3 need not be separated, which can make the pixel more suitable for a high resolution display apparatus.

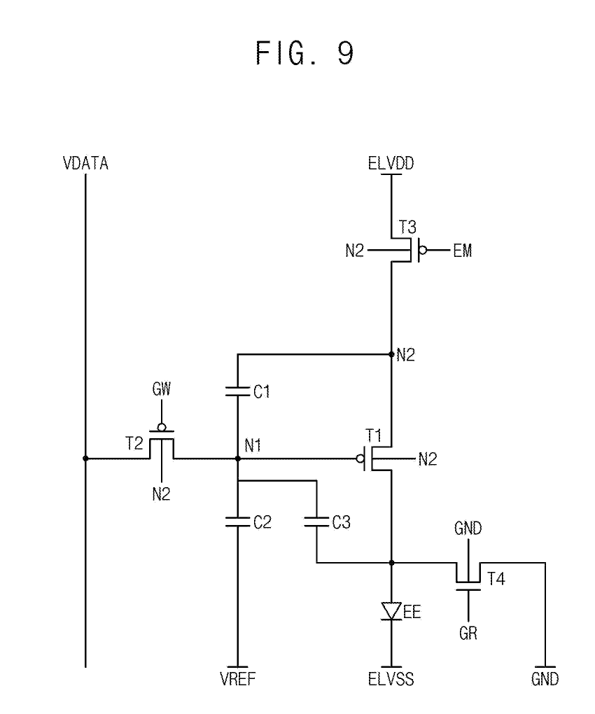

FIG. 9 is a circuit diagram illustrating a pixel of a display panel 100 of a display apparatus according to an embodiment of the present inventive concept.

The display apparatus according to the present embodiment is substantially the same as the display apparatus of the previous embodiment explained referring to FIGS. 1 to 7 except for the fourth switching element of the pixel. Thus, the same reference numerals will be used to refer to the same or like parts as those described in the previous embodiment of FIGS. 1 to 7 and any repetitive explanation concerning the above elements will be omitted.

Referring to FIGS. 1, 3 to 7 and 9, the display panel 100 includes a plurality of pixels. Each of the pixels includes a light emitting element EE. For example, the light emitting element EE may be a micro organic light emitting diode (Micro-OLED).

The pixel receives a first gate signal GW, a second gate signal GR, the data voltage VDATA and the emission signal EM and the light emitting element EE of the pixel emits light corresponding to the level of the data voltage VDATA to display the image.

The pixel includes the light emitting element EE, a first switching element T1, a second switching element T2, a third switching element T3 and a fourth switching element T4.

The first switching element T1 includes a control electrode connected to a first node N1, a first electrode connected to a second node N2 and a second electrode connected to an anode electrode of the light emitting element EE. The first switching element T1 may further include a body electrode connected to the second node N2. The body electrode of the first switching element T1 may be connected to a source electrode of the first switching element T1.

The fourth switching element T4 includes a control electrode receiving the second gate signal GR, a first electrode receiving a first voltage and a second electrode connected to the anode electrode of the light emitting element EE. In the present embodiment, the first voltage may be a ground voltage GND. The fourth switching element T4 includes the control electrode receiving the second gate signal GR, the first electrode connected to a ground GND and the second electrode connected to the anode electrode of the light emitting element EE.

For example, the fourth switching element T4 may further include a body electrode connected to the ground GND.

A second power voltage ELVSS is applied to a cathode electrode of the light emitting element EE.

The pixel may further include a first capacitor C1 including a first electrode connected to the first node N1 and a second electrode connected to the second node N2 and a second capacitor C2 including a first electrode connected to the first node N1 and a second electrode receiving a second voltage (e.g. a reference voltage VREF). In the present embodiment, the second voltage VREF may be different from the first voltage VINT.

The pixel may further include a third capacitor C3 including a first electrode connected to the first node N1 and a second electrode connected to the anode electrode of the light emitting element EE.

In the present embodiment, the first switching element T1, the second switching element T2 and the third switching element T3 may be P-type transistors. The fourth switching element T4 may be an N-type transistor.

For example, the second switching element T2 may further include a body electrode receiving the first power voltage ELVDD. For example, the third switching element T3 may further include a body electrode receiving the first power voltage ELVDD.

For example, the body electrode of the second switching element T2 may be connected to the source electrode of the first switching element T1. In addition, the body electrode of the third switching element T3 may be connected to the source electrode of the first switching element T1.

According to the present embodiment, the body electrode of the first switching element T1 is connected to the source electrode N2 of the first switching element T1, such that the voltage of the body electrode of the first switching element T1 and the voltage of the source electrode of the first switching element T1 may be matched in both the compensation period P2 and in the light emission period P4.

When the voltage of the body electrode of the first switching element T1 and the voltage of the source electrode of the first switching element T1 are matched in the compensation period P2 and in the light emission period P4, the threshold voltage of the first switching element T1 may be adequately compensated.

Thus, luminance uniformity of the display panel 100 and the display quality of the display panel 100 may be enhanced.

The pixel may include four switching elements T1, T2, T3 and T4 and three capacitors C1, C2 and C3. This relatively small number of switching elements and capacitors may allow the pixel to be applied to a high resolution display apparatus.

In addition, when the body electrode of the second switching element T2 and the body electrode of the third switching element T3 are connected to the source electrode N2 of the first switching element T1, the body electrodes of the first to third switching elements T1 to T3 are connected to the same node so that wells between the first to third switching elements T1 to T3 need not be separated. As a result, the pixel may be more suitable for application in a high resolution display apparatus.

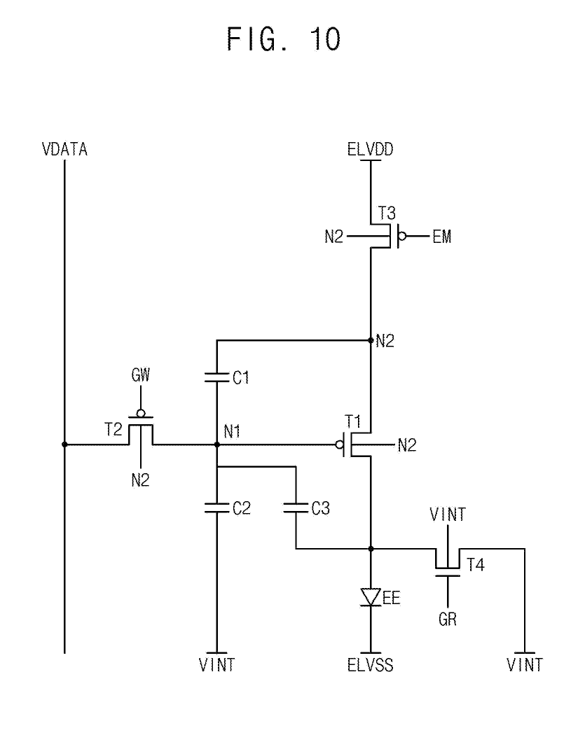

FIG. 10 is a circuit diagram illustrating a pixel of a display panel 100 of a display apparatus according to an embodiment of the present inventive concept.

The display apparatus according to the present embodiment is substantially the same as the display apparatus of the previous embodiment explained referring to FIGS. 1 to 7 except for the second capacitor of the pixel. Thus, the same reference numerals will be used to refer to the same or like parts as those described in the previous embodiment of FIGS. 1 to 7 and any repetitive explanation concerning the above elements will be omitted.

Referring to FIGS. 1, 3 to 7 and 10, the display panel 100 includes a plurality of pixels. Each of the pixels includes a light emitting element EE. For example, the light emitting element EE may be a micro organic light emitting diode (Micro-OLED).

The pixel receives a first gate signal GW, a second gate signal GR, the data voltage VDATA and the emission signal EM and the light emitting element EE of the pixel emits light corresponding to the level of the data voltage VDATA to display the image.

The pixel includes the light emitting element EE, a first switching element T1, a second switching element T2, a third switching element T3 and a fourth switching element T4.

The first switching element T1 includes a control electrode connected to a first node N1, a first electrode connected to a second node N2 and a second electrode connected to an anode electrode of the light emitting element EE. The first switching element T1 may further include a body electrode connected to the second node N2. The body electrode of the first switching element T1 may be connected to a source electrode of the first switching element T1.

The fourth switching element T4 includes a control electrode receiving the second gate signal GR, a first electrode receiving a first voltage and a second electrode connected to the anode electrode of the light emitting element EE. In the present embodiment, the first voltage may be an initialization voltage VINT. The fourth switching element T4 includes the control electrode receiving the second gate signal GR, the first electrode receiving the initialization voltage VINT and the second electrode connected to the anode electrode of the light emitting element EE.

For example, the fourth switching element T4 may further include a body electrode receiving the initialization voltage VINT.

A second power voltage ELVSS is applied to a cathode electrode of the light emitting element EE.

The pixel may further include a first capacitor C1 including a first electrode connected to the first node N1 and a second electrode connected to the second node N2 and a second capacitor C2 including a first electrode connected to the first node N1 and a second electrode receiving a second voltage. In the present embodiment, the second voltage may be substantially the same as the first voltage. In the present embodiment, the second voltage may be the initialization voltage VINT.

The pixel may further include a third capacitor C3 including a first electrode connected to the first node N1 and a second electrode connected to the anode electrode of the light emitting element EE.

In the present embodiment, the first switching element T1, the second switching element T2 and the third switching element T3 may be P-type transistors. The fourth switching element T4 may be an N-type transistor.

For example, the second switching element T2 may further include a body electrode receiving the first power voltage ELVDD. For example, the third switching element T3 may further include a body electrode receiving the first power voltage ELVDD.

For example, the body electrode of the second switching element T2 may be connected to the source electrode of the first switching element T1. In addition, the body electrode of the third switching element T3 may be connected to the source electrode of the first switching element T1.

According to the present embodiment, the body electrode of the first switching element T1 is connected to the source electrode N2 of the first switching element T1, so that the voltage of the body electrode of the first switching element T1 and the voltage of the source electrode of the first switching element T1 may be matched in the compensation period P2 and in the light emission period P4.

When the voltage of the body electrode of the first switching element T1 and the voltage of the source electrode of the first switching element T1 are matched in the compensation period P2 and in the light emission period P4, the threshold voltage of the first switching element T1 may be adequately compensated.

Thus, luminance uniformity of the display panel 100 and the display quality of the display panel 100 may be enhanced.

The pixel may include four switching elements T1, T2, T3 and T4 and three capacitors C1, C2 and C3. This relatively small number of switching elements and capacitors may allow the pixel to be applied to a high resolution display apparatus.

In addition, when the body electrode of the second switching element T2 and the body electrode of the third switching element T3 are connected to the source electrode N2 of the first switching element T1, the body electrodes of the first to third switching elements T1 to T3 are connected to the same node so that wells between the first to third switching elements T1 to T3 need not be separated. As a result, the pixel may be more suitable for application in a high resolution display apparatus.

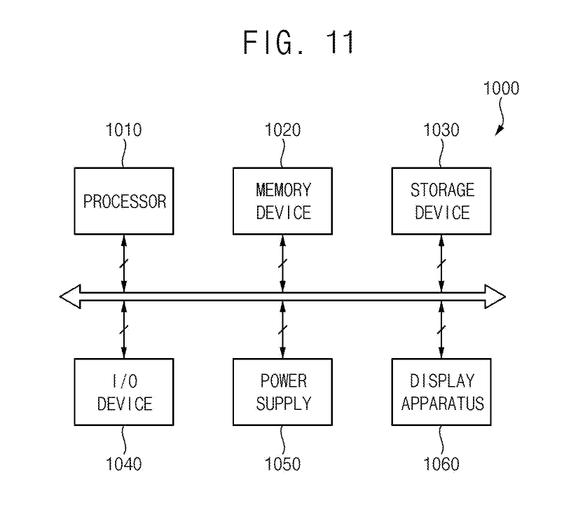

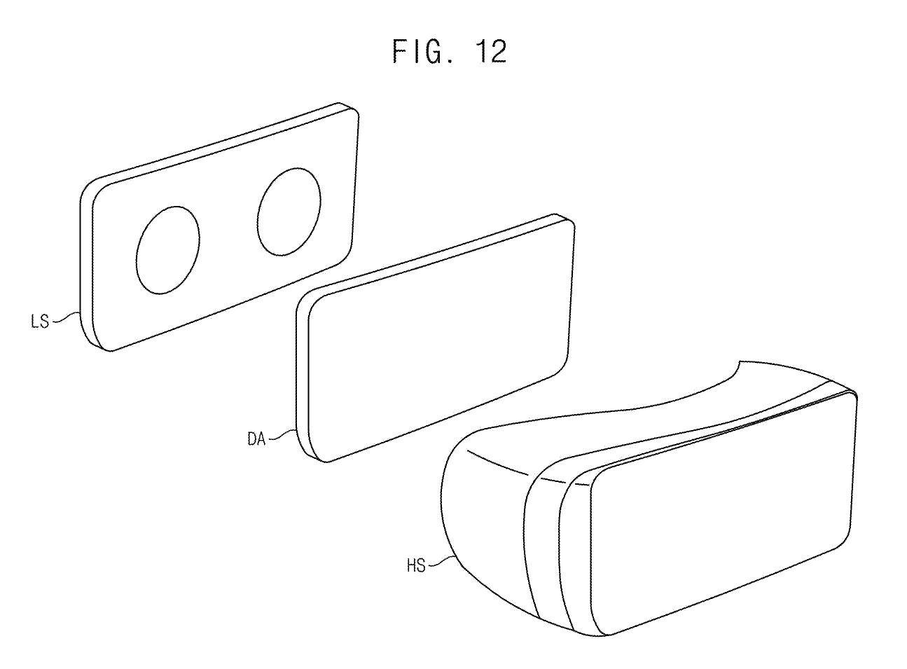

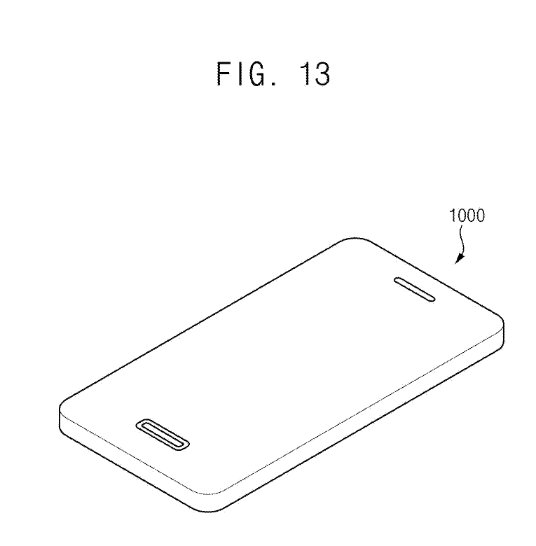

FIG. 11 is a block diagram illustrating an electronic apparatus 1000 according to an embodiment of the present inventive concept. FIG. 12 is a diagram illustrating an example in which the electronic apparatus 1000 of FIG. 11 is implemented as the VR display system. FIG. 13 is a diagram illustrating an example in which the electronic apparatus 1000 of FIG. 11 is implemented as a smartphone.

Referring to FIGS. 1 to 13, the electronic apparatus 1000 may include a processor 1010, a memory device 1020, a storage device 1030, an input/output (I/O) device 1040, a power supply 1050, and a display apparatus 1060. Here, the display apparatus 1060 may be the display apparatus of FIG. 1. In addition, the electronic apparatus 1000 may further include a plurality of ports for communicating with a video card, a sound card, a memory card, a universal serial bus (USB) device, other electronic apparatuses, etc.

In an embodiment, as illustrated in FIG. 13, the electronic apparatus 1000 may be implemented as a smartphone. However, the electronic apparatus 1000 is not limited thereto. For example, the electronic apparatus 1000 may be implemented as a cellular phone, a video phone, a smartpad, a smartwatch, a tablet PC, a car navigation system, a computer monitor, a laptop, a head mounted display (HMD) device, and the like.

The processor 1010 may perform various computing functions or various tasks. The processor 1010 may be a micro-processor, a central processing unit (CPU), an application processor (AP), and the like. The processor 1010 may be coupled to other components via an address bus, a control bus, a data bus, etc. Further, the processor 1010 may be coupled to an extended bus such as a peripheral component interconnection (PCI) bus.

The processor 1010 may output the input image data IMG and the input control signal CONT to the driving controller 200 of FIG. 1.

The memory device 1020 may store data for operations of the electronic apparatus 1000. For example, the memory device 1020 may include at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, and the like and/or at least one volatile memory device such as a dynamic random access memory (DRAM) device, a static random access memory (SRAM) device, a mobile DRAM device, and the like.

The storage device 1030 may include a solid state drive (SSD) device, a hard disk drive (HDD) device, a CD-ROM device, and the like. The I/O device 1040 may include an input device such as a keyboard, a keypad, a mouse device, a touch-pad, a touch-screen, and the like and an output device such as a printer, a speaker, and the like. In some embodiments, the display apparatus 1060 may be included in the I/O device 1040. The power supply 1050 may provide power for operations of the electronic apparatus 1000. The display apparatus 1060 may be coupled to other components via the buses or other communication links.

Referring to FIG. 12, the VR display system may include a lens LS, a display apparatus DA and a housing HS. The display apparatus DA may be disposed adjacent to the lens LS. The housing HS may accommodate the lens LS and the display apparatus DA. Although FIG. 12 illustrates the lens LS and the display apparatus DA accommodated on a first side of the housing HS in FIG. 12, the present inventive concept is not limited thereto. For example, the lens LS may be mounted on a first side of the housing HS and the display apparatus DA may be mounted on a second side of the housing HS opposite to the first side of the housing HS. When the lens LS and the display apparatus are mounted on opposite sides with respect to the housing HS, the housing HS may include a transmitting portion configured to transmit light from the display apparatus DA toward the lens LS.

For example, the VR display system may be a head mounted display system worn on a user’s head. The VR display system may further include a head band configured to secure the VR display system to the user’s head.

Alternatively, the VR display system may be implemented in the form of smartglasses having a shape of glasses (e.g., eyewear).

In addition, the electronic apparatus may be implemented as an augmented reality (AR) display system for supporting augmented reality. The AR display system may have a smartphone shape, a smartglasses shape, a head mounted display shape, etc., but is not limited to those shapes.

In addition, the electronic apparatus may be implemented as a mixed reality (MR) display system for supporting mixed reality. The MR display system may have a smartphone shape, a smartglasses shape, a head mounted display shape, etc., but is not limited to those shapes.

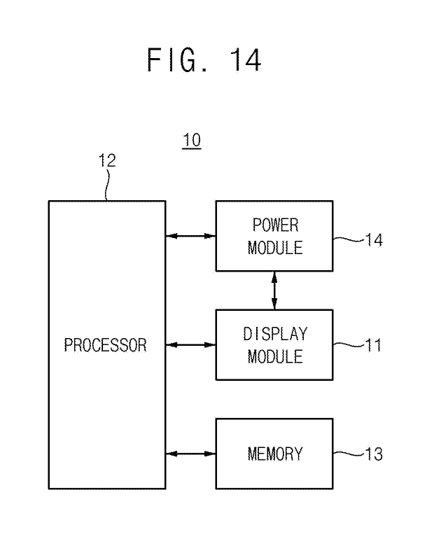

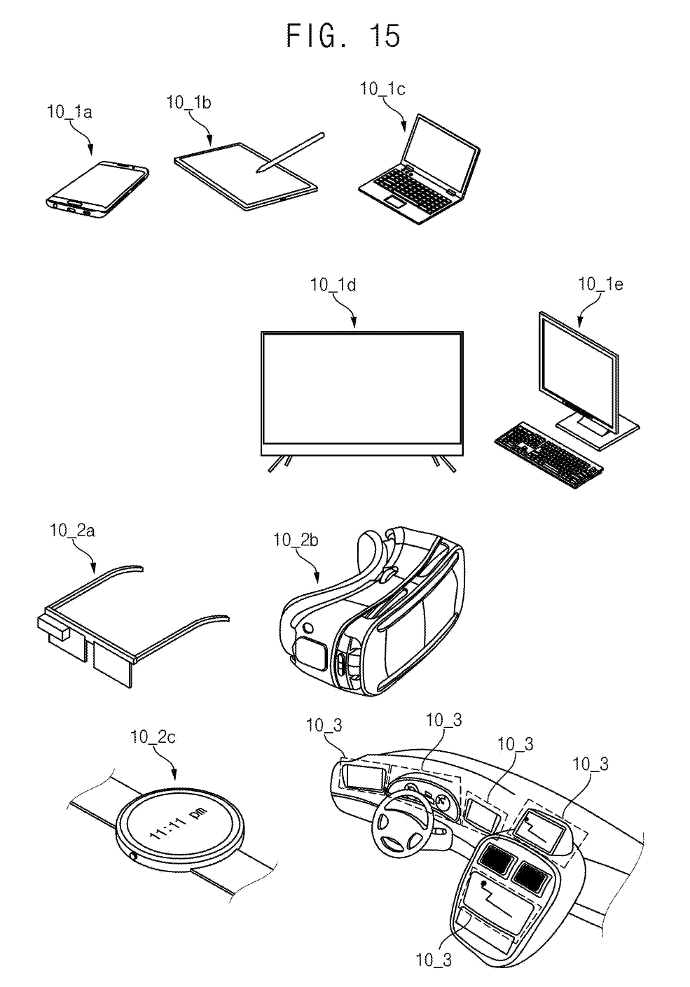

FIG. 14 is a block diagram illustrating an electronic apparatus 10 according to an embodiment of the present inventive concept. FIG. 15 are schematic diagrams illustrating the electronic apparatuses 10 of FIG. 14.

Referring to FIG. 14, the electronic apparatus 10 according to an embodiment may include a display module 11, a processor 12, a memory 13 and a power module 14.

The display apparatus according to the embodiment of the present inventive concept may be applied to various electronic apparatuses.

In an embodiment, the electronic apparatus 10 may include the display apparatus of FIG. 1. An operation of the display apparatus included in the electronic apparatus 10 may be substantially the same as the operation of the display apparatus explained referring to FIGS. 1 to 10. The electronic apparatus 10 may further include a module or an apparatus having additional functions in addition to the display apparatus.

The processor 12 may include at least one of a central processing unit (CPU), an application processor (AP), a graphic processing unit (GPU), a communication processor (CP), an image signal processor (ISP) and a controller.

In an embodiment, the processor 12 may provide the input control signal CONT of FIG. 1 and the input image data IMG of FIG. 1 to the driving controller 200 included in the display apparatus of FIG. 1.

In an embodiment, the processor 12 may be divided into two or more in a functional or structural perspective. For example, the processor 12 may include a main processor, which is a first driving chip type, including the central processing unit and an auxiliary processor, which is a second driving chip type, including a controller receiving an image signal from the main processor and processing the image signal to match interface specifications of the display module 11. For example, the auxiliary processor may include the driving controller 200 included in the display apparatus of FIG. 1. Thus, the main processor may provide the input control signal CONT of the FIG. 1 and the input image data IMG of FIG. 1 to the auxiliary processor. The auxiliary processor may process the image signal based on the input control signal CONT and the input image data IMG.

The memory 13 may include at least one of a nonvolatile memory and a volatile memory. Data information required for the operation of the processor 12 or the display module 11 may be stored in the memory 13. When the processor 12 executes an application stored in the memory 13, the input control signal CONT and/or the input image data IMG may be transmitted to the display module 11 and the display module 11 may process the input control signal CONT and/or the input image data IMG and may output image information through a display area.

The power module 14 may include a power supply module, such as a power adapter or a battery device, and a power conversion module converting power supplied by the power supply module to generate a power required for the operation of the electronic apparatus 10.

At least one of the elements of the electronic apparatus 10 may be included in the display apparatus according to embodiments of the present inventive concept. In addition, a part of a single functional module may be included in the display apparatus and another part of the single functional module may be disposed out of the display apparatus. For example, the display module 11 may be included in the display apparatus but the processor 12, the memory 13 and the power module 14 may be included in another apparatus in the electronic apparatus 10 which is not the display apparatus.

Referring to FIG. 15, the various electronic apparatuses including the display apparatus according to the present embodiments may include electronic apparatuses for displaying image such as a smartphone 10_1a, a tablet PC 10_1b, a laptop 10_1c, a television 10_1d, a desktop monitor 10_1e, wearable electronic apparatuses including a display module such as smartglasses 10_2a, a head mounted display 10_2band a smartwatch 10_2c and vehicle electronic apparatuses 10_3 including display modules such as a CID (center information display), a room mirror display disposed on an instrument panel, center fascia, and a dashboard of a vehicle. The electronic apparatus 10 may not be limited to the electronic apparatuses for displaying image, the wearable electronic apparatuses and the vehicle electronic apparatuses 10_3.

According to one or more embodiments explained above, luminance uniformity of a display panel of a display apparatus may be enhanced and display quality of the display panel may be enhanced. In addition, pixels of the display panel may be applied to a high resolution display apparatus.

The foregoing is illustrative of the present inventive concept and is not to be construed as limiting thereof. Although a few example embodiments of the present inventive concept have been described, those skilled in the art will readily appreciate that many modifications are possible in the example embodiments without materially departing from the present inventive concept. Accordingly, all such modifications are intended to be included within the scope of the present inventive concept as defined in the claims. In the claims, means-plus-function clauses are intended to cover the structures described herein as performing the recited function and not only structural equivalents but also equivalent structures. Therefore, it is to be understood that the foregoing is illustrative of the present inventive concept and is not to be construed as limited to the specific example embodiments disclosed, and that modifications to the disclosed example embodiments, as well as other example embodiments, are intended to be included within the scope of the appended claims.

What is claimed is:

1. A pixel comprising:
a light emitting element;
a first switching element including a control electrode connected to a first node, a first electrode connected to a second node and a second electrode connected to the light emitting element;
a second switching element including a control electrode configured to receive a first gate signal, a first electrode connected to a data line and a second electrode connected to the first node;
a third switching element including a control electrode configured to receive an emission signal, a first electrode configured to receive a first power voltage and a second electrode connected to the second node; and
a fourth switching element including a control electrode configured to receive a second gate signal, a first electrode configured to receive a first voltage and a second electrode connected to the light emitting element,
wherein the light emitting element is configured to receive a second power voltage, and
wherein the first switching element further includes a body electrode connected to the second node.

2. The pixel of claim 1, wherein the second switching element further includes a body electrode connected to the second node.

3. The pixel of claim 1, wherein the third switching element further includes a body electrode connected to the second node.

4. The pixel of claim 1, wherein the second switching element further includes a body electrode connected to the second node, and
wherein the third switching element further includes a body electrode connected to the second node.

5. The pixel of claim 1, wherein the first switching element, the second switching element and the third switching element are P-type transistors, and
wherein the fourth switching element is an N-type transistor.

6. The pixel of claim 1, wherein the first electrode of the fourth switching element is configured to receive an initialization voltage.

7. The pixel of claim 6, wherein the fourth switching element further includes a body electrode configured to receive the initialization voltage.

8. The pixel of claim 1, wherein the first electrode of the fourth switching element is configured to receive the second power voltage.

9. The pixel of claim 8, wherein the fourth switching element further includes a body electrode configured to receive the second power voltage.

10. The pixel of claim 1, wherein the first electrode of the fourth switching element is connected to a ground.

11. The pixel of claim 10, wherein the fourth switching element further includes a body electrode connected to the ground.

12. The pixel of claim 1, further comprising:
a first capacitor including a first electrode connected to the first node and a second electrode connected to the second node; and
a second capacitor including a first electrode connected to the first node and a second electrode configured to receive a second voltage.

13. The pixel of claim 12, further comprising a third capacitor including a first electrode connected to the first node and a second electrode connected to the light emitting element.

14. The pixel of claim 12, wherein the first voltage is substantially the same as the second voltage.

15. The pixel of claim 1, wherein the emission signal has an active level in a first period,
wherein the first gate signal has an active level in the first period,
wherein the second gate signal has an active level in the first period,
wherein the first power voltage has a first level in the first period, and
wherein the first switching element, the second switching element, the third switching element and the fourth switching element are turned on in the first period.

16. The pixel of claim 15, wherein the emission signal has an inactive level in a second period subsequent to the first period,
wherein the first gate signal has the active level in the second period,
wherein the second gate signal has the active level in the second period,
wherein the first power voltage has a second level lower than the first level in the second period,
wherein a voltage difference between the body electrode of the first switching element and the first electrode of the first switching element is less than a threshold voltage of the third switching element in the second period,
wherein the first switching element, the second switching element and the fourth switching element are turned on in the second period, and
wherein the third switching element is turned off in the second period.

17. The pixel of claim 16, wherein the emission signal has the active level in a third period subsequent to the second period,
wherein the first gate signal has an inactive level in the third period,
wherein the second gate signal has the active level in the third period,
wherein the first power voltage has the first level in the third period,
wherein the first switching element, the third switching element and the fourth switching element are turned on in the third period, and
wherein the second switching element is turned off in the third period.

18. The pixel of claim 17, wherein the emission signal has the active level in a fourth period subsequent to the third period,
wherein the first gate signal has the inactive level in the fourth period,
wherein the second gate signal has an inactive level in the fourth period,
wherein the first power voltage has the first level in the fourth period,
wherein the first switching element and the third switching element are turned on in the fourth period, and
wherein the second switching element and the fourth switching element are turned off in the fourth period.

19. A display apparatus comprising:
a display panel including a pixel;
a gate driver configured to output a gate signal to the pixel; and
a data driver configured to output a data voltage to the pixel,
wherein the pixel comprises:
a light emitting element;
a first switching element including a control electrode connected to a first node, a first electrode connected to a second node and a second electrode connected to the light emitting element;
a second switching element including a control electrode configured to receive a first gate signal, a first electrode connected to a data line and a second electrode connected to the first node;
a third switching element including a control electrode configured to receive an emission signal, a first electrode configured to receive a first power voltage and a second electrode connected to the second node; and
a fourth switching element including a control electrode configured to receive a second gate signal, a first electrode configured to receive a first voltage and a second electrode connected to the light emitting element,
wherein the light emitting element is configured to receive a second power voltage, and
wherein the first switching element further includes a body electrode connected to the second node.

20. An electronic device comprising:
a display panel including a pixel;
a gate driver configured to output a gate signal to the pixel;
a data driver configured to output a data voltage to the pixel;
a driving controller configured to control an operation of the gate driver and an operation of the data driver; and
a processor configured to output input image data and an input control signal to the driving controller,
wherein the pixel comprises:
a light emitting element;
a first switching element including a control electrode connected to a first node, a first electrode connected to a second node and a second electrode connected to the light emitting element;
a second switching element including a control electrode configured to receive a first gate signal, a first electrode connected to a data line and a second electrode connected to the first node;
a third switching element including a control electrode configured to receive an emission signal, a first electrode configured to receive a first power voltage and a second electrode connected to the second node; and
a fourth switching element including a control electrode configured to receive a second gate signal, a first electrode configured to receive a first voltage and a second electrode connected to the light emitting element,
wherein the light emitting element is configured to receive a second power voltage, and
wherein the first switching element further includes a body electrode connected to the second node.
